(19) United States
(12) Patent Application Publication
(10) Pub. No.: US 2006/0151147 A1
(43) Pub. Date: Jul. 13, 2006

(54) Heat exchanger and/or chemical reactor

(76) Inventor: Keith Symonds, Wolverhampton (GB)

Correspondence Address: PATENT GROUP;ATTN: J. KENNETH JOUNG, DLA PIPER RUDNICK GRAY CARY US LLP, 203 N. LASALLE ST., SUITE 1900, CHICAGO, IL, 60601, US

(21) Appl. No.: 10/532,886

(22) PCT Filed: Sep. 5, 2003
(86) PCT No.: PCT/GB03/03848

§ 371 Date: Apr. 27, 2005

(30) Foreign Application Priority Data
Sep. 5, 2002 (GB) 0220652.2

(51) Int. Cl. B60H 1/00; F28D 7/02; G05D 15/00; G05D 23/00; G05D 16/00

(52) U.S. Cl. 165/11.1; 165/284; 165/297; 165/164

(57) ABSTRACT

Heat exchange and/or chemical reactor apparatus (10; 100) comprises a series of plates which are stacked and bonded together in a fluid-tight manner, the series of plates comprising alternate first (30; 130 ) and second (90; 190) plates or groups of plates along the stack providing flow paths for respective first and second fluids, each plate forming said first (30; 130) and second (90; 190) plates or groups of plates having an inlet (42, 90) and an outlet (43, 91) between which respective first or second fluid is flowable and a continuous wall (34, 84) to contain the flow of fluid, and characterised in that each plate (30, 90; 130; 190) comprises an outer wall (43, 83) continuous wall (34, 84) to define a space (35, 85) therebetween, the spaces (35, 85) of each plate (30, 90; 130; 190) of the stack being in fluid communication to form a compartment running along the stack.

This invention relates to a heat exchanger and/or chemical reactor and particularly to such apparatus which is formed from a stack of plates bonded together.

The invention is particularly intended to provide a heat exchanger and/or chemical reactor of a compact design having high “area density”, i.e. having a high ratio of heat transfer surface to heat exchanger volume. Area density may typically, be greater than 300 m²/m³ and may be more than 700 m²1m³.

The invention is also particularly intended to provide means to monitor or indicate the leak of a fluid to be cooled, a cooling fluid or both from the heat exchanger and/or chemical reactor. This of particular use when one or both of the fluids are dangerous, say flammable, explosive, carcinogenic or so on, or may react together to form such a dangerous substance when mixed, or other situations where it is necessary to prevent leakages.

One such example is in the cooling of engine oil in aerospace and other applications where fuel is used as the cooling fluid. A leak of either or both of the fluids may be dangerous because of the risk of explosion or because the, say, aeroplane may have a limited supply of fuel, oil or both. Other uses are in chemical plants where two fluids which are being cooled and/or reacted together should not be allowed to leak, either individually or together, due to efficiency and/or safety considerations.

In aerospace embodiments, where fuel is used to cool oil, there is often a need to include a bypass valve in the construction whereby the oil may bypass the cooling effect of the heat exchanger until cooling is actually needed, i.e. to avoid overcooling of the oil and consequent poor oil circulation. The current invention is intended to meet the need of that particular use also.

In aerospace applications as mentioned above, oil is generally used as a lubricant for moving parts and in doing so takes in heat energy generated by friction and also as a consequence of being circulated under pressure by a pump. In order that the oil is maintained in an optimum condition to act as a lubricant its temperature must be controlled within quite close limits. Thus it must be cooled within a heat exchanger, which is frequently of the shell and tube type. The cooling medium used would typically be the actual reservoir of fuel that is used to power the engine.

When an aircraft engine, for example, is first started, both fuel and oil are cold and so initially the oil requires no cooling and in fact may remain in this condition for some time even though both the oil and fuel are still circulating. Thus the oil needs to bypass the region being cooled by the fuel until its temperature reaches a point at which cooling becomes beneficial. This can be arranged by incorporating a pressure relief and/or a thermal-pressure relief valve. Its purpose is to ensure that oil is forced to pass through the cooling section when the oil needs cooling, but to ensure that it does not do so when cooling would be detrimental. Savings in space and cost can be achieved if the valve or valves that control these functions are mounted adjacent to, or preferably integral with, the heat exchanger.

When one or both of the fluids, between which heat is exchanged, pass through a heat exchanger at a high pressure (or at least at a pressure in excess of the ambient atmospheric pressure), stresses and/or strains are placed upon the heat exchanger by passage of the pressurised fluid(s). In some systems, such as fuel systems in aircraft, the fuel is pumped to the engines at very high pressures, typically 2 MPa (20 atm). Oil is typically pumped at 1 MPa (10 atm). Clearly, with volatile and/or combustible substances, such as aircraft fuel, it is a desideratum to prevent leakages. If such substances escape from high-pressure systems they may vaporise rapidly and, in the presence of air, can form a stoichiometric mix which is explosive in the presence of say, a spark.

A leakage may occur through fatigue of a part, for example through exposure to high-pressure fluids and/or thermal cycling regimes, or through using imperfect material in or indeed, imperfect or incomplete fabrication of, a heat exchanger. In either or any case of a leakage, it is a desideratum to contain the leakage to prevent, or at least control, venting of the fluid to the surrounding atmosphere. It is a further desideratum to provide means to notify or signal an operator or person or system monitoring the apparatus that such a leak has occurred.

It is an object of this invention to satisfy the above desiderata, whilst providing a heat exchanger which is relatively economical and simple to both manufacture and assemble. Other and further objects of the invention will become apparent from what is disclosed.

For example, in our co-pending international (PCT) patent application no. PCT/GB02/02636 (published as WO 02/101313) we disclose and claim a heat exchanger with an integrally-formed bypass valve, which heat exchanger can be manufactured by diffusion bonding or, e.g., furnace brazing.

A first aspect of that invention provides a heat exchanger comprising a series of plates which are stacked and bonded together in fluid tight manner, the plates of the stack comprising an end plate at each end of the stack and alternate first and second groups of plates along the stack, the first and second groups providing flow paths for a first and second fluid respectively, the peripheries of the plates having integral, outwardly extending loops, the loops stacking together to provide inlet and outlet tanks for first and second fluids on the exterior of the stack, the tanks communicating with the flow paths of the groups of plates via an inlet and an outlet for the respective fluids into and out of their respective groups of plates, each group of first plates being separated by a solid plate from an adjacent second group of plates, each plate of the stack having a centrally disposed hole defined by an annular surround, the aligned holes forming a bore through the stack, the flow path for each first group of plates being configured to flow from its inlet towards the annular surrounds of its plates and then to turn towards the outer peripheral edges of the plates at a position adjacent but spaced from the inlet and to continue with successive inward and outward flow around the group of plates until its respective outlet is reached, the annular surrounds of a first group of plates adjacent one end of the stack having one or more apertures leading into the central bore and the bore containing a movable valve member which in a first position prevents flow through the bore and in a second position provides a fluid bypass route through the bore.

It is a further desired feature of the invention that a by-pass valve as considered in our previous application may be incorporated.

Accordingly, a first aspect of the current invention provides a heat exchanger comprising a series of plates which are stacked and bonded together in a fluid-tight manner, the series of plates comprising alternate first and second plates or groups of plates along the stack providing flow paths for respective first and second fluids, each plate forming said first and second plates or groups of plates having an inlet and an outlet between which respective first or second fluid is flowable and a continuous wall to contain the flow of fluid, and characterised in that each plate comprises an outer wall at least partially encompassing the continuous wall to define a space therebetween, the spaces of each plate of the stack being in fluid communication to form a compartment running along the stack.

Each continuous wall may comprise integral, outwardly extending loops, the loops being stacked together to provide inlet and outlet reservoirs for first and second fluids, the respective reservoirs communicating with the flow paths of the groups of plates via the inlet and the outlet for the respective fluids into and out of their respective groups of plates.

The alternate first and second plates may be separated by a single intervening plate or intervening group of plates.

An intervening group of plates may comprise a sandwich of single intervening plate—one or more interlayer plates—single intervening plate. The or each interlayer plate may comprise a first wall and a continuous outer wall encompassing the first wall to define a space therebetween, the region defined by the first wall being in fluid communication with said space. Preferably, the first wall comprises one or more vents extending through, say, half the thickness of the interlayer plate to provide fluid communication between the space and the region defined by the first wall. The space will comprise a part of the compartment in the stack of plates which, consequently, will be in fluid communication with the region defined by the first wall.

The or each single intervening plate, either used individually or as part of the above-described sandwich, will have a solid portion to prevent fluid communication between said first and second groups of plates or between said first or second group of plates and the or each interlayer plate, the single intervening plate will have a outer wall encompassing and joined to its solid periphery, a space being defined between the outer wall and the solid periphery which, in the stack of plates, communicates with the spaces of the plates of the first and second groups of plates, and interlayer plate if present, to comprise a portion of the compartment.

The compartment will, preferably, be sealed at either end and will preferably comprise leak detection means. Said leak detection means may comprise pressure sensors, such as valves or pressure transducers or devices which can directly detect or indicate the presence of leaking fluids such as spectrometers, indicating chemicals and the like. In normal operation, the pressure in the compartment will be less than that experienced by the first and/or second fluids in the heat exchanger.

Each plate of the stack may also comprise a centrally disposed hole defined by a surround, for example an annular surround, the aligned holes forming a bore through the stack.

Preferably, the, say annular, surrounds of a first group of plates adjacent one end of the stack have one or more apertures leading into the central bore. The bore may contain a movable valve member which in a first position prevents flow through the bore and in a second position provides a fluid bypass route through the bore.

The movable valve member may be a conventional valve arrangement. Thus the valve member may have a stem and valve seat, the latter co-operating with a corresponding seat defined in the central bore. The opening and closing of the bypass valve may be temperature and/or pressure controlled. It may be spring controlled and/or operated by mechanical linkage.

A more specific aspect of the invention provides a heat exchanger comprising a series of plates which are stacked and bonded together in fluid tight manner, the plates of the stack comprising an end plate at each end of the stack and alternate first and second groups of plates along the stack, the first and second groups providing flow paths for a first and second fluid respectively, each plate having a continuous wall to contain flow of fluid, each continuous wall comprising integral, outwardly extending loops, the loops being stacked together to provide inlet and outlet reservoirs for first and second fluids, the reservoirs communicating with the flow paths of the groups of plates via an inlet and an outlet for the respective fluids into and out of their respective groups of plates, each group of first plates being separated by an intervening plate or intervening group of plates from an adjacent second group of plates, each plate of the stack having a centrally disposed hole defined by an annular surround, the aligned holes forming a bore through the stack, the flow path for each first group of plates being configured to allow flow from its inlet towards the annular surrounds of its plates and then to turn towards the continuous wall of its plates at a position adjacent but spaced from the inlet and to continue with successive inward and outward flow around the group of plates until its respective outlet is reached, the annular surrounds of a first group of plates adjacent one end of the stack having one or more apertures leading into the central bore and the bore containing a movable valve member which in a first position prevents flow through the bore and in a second position provides a fluid bypass route through the bore, and characterised in that each plate comprises an outer wall encompassing the continuous wall to define a space therebetween, the spaces of each plate of the stack being in fluid communication to form a compartment running up and down the stack.

In a preferred embodiment, another first group of plates positioned adjacent the other end of the stack also has apertures in the, say annular, surrounds of its plates. Thus, first fluid, e.g. oil, when the valve member is in the first position, may flow into the first fluid inlet tank via an inlet at one end of the stack, fill the inlet tank on the outside of the stack, flow from the inlet tank across each group of first plates via their respective inlets, out through their respective outlets and finally out through an outlet at the opposite end of the tank. However, if the valve member is in the second position, the first fluid will pass from its stack inlet to fill the inlet tank and will preferentially flow across the first group of plates at the inlet end of the stack, pass through the apertures into the central bore and along the central bore to reach the first fluid outlet via the apertures in the annular surrounds of the plates at the other end of the stack. Thus the first fluid will not pass to any significant extent across intermediate first groups of plates in this mode and little or no heat exchange will take place.

Where the heat exchanger is to be used to cool engine oil, as referred to above, the oil can circulate around alternate first groups of plates in the stack and the engine fuel can circulate around alternate second groups of plates sandwiching the first groups of plates containing the circulating oil. It will be appreciated that, as indicated above, it will normally only be necessary for the first and last first groups of plates in the stack to contain apertures in their annular surrounds to allow flow of oil, when required, into and then out of the central bore.

Conveniently, the flow paths of the second fluid through the second groups of plates may be similar to those of the first fluid, i.e. they may provide successive inward and outward flow as the paths travel around the plates from the inlet to the outlet of their respective groups. Flow of second fluid into the central bore will not be permitted.

Improved heat transfer between the two circulating fluids may be achieved by causing them to pass in opposite directions to each other as they pass around their respective groups of plates.

The plates of a group of plates may be provided with any convenient means to provide the desired inward and outward flow to circulate between the inlet and outlet of the group. For example, the respective fluids may flow around each plate in a tortuous fashion. In such an embodiment it is convenient to place the inlet and outlet side by side at the outer peripheral edge of the plates so that fluid circulation is completely around the plates. If the respective fluids flow across respective plates then the inlet and outlet will be located transversely of the plate. Other configurations are possible, as will be appreciated by the skilled addressee.

In one preferred embodiment, the plates are of the so-called “pin-fin” type, particularly as described in our co-pending international (PCT) patent application no. PCT/GB99/01622, publication number WO 99/66280 and in our co-pending international (PCT) patent application no. PCT/GB02/02636 (WO 02/101313). In PCT/GB99/01622 there is described a heat exchanger comprising a stack of parallel perforated plates, each plate of the stack having perforations, characterised in that the perforations define an array of spaced column precursors, of thickness equal to the plate thickness, the column precursors being joined together by ligaments, each ligament extending between a pair of adjacent column precursors, the ligaments having a thickness less than the plate thickness, the column precursors of any one plate being coincident in the stack with the column precursors of any adjacent plate whereby the stack is provided with an array of individual columns, each column extending perpendicularly to the plane of the plates, whereby fluid flowing through the stack is forced to follow a tortuous flow path to flow around the columns.

Thus the plates of each first group and, if desired, of each second group and of the interlayer plates used in the present invention may contain column precursors and ligaments as described in WO 99/66280, the column precursors of adjacent plates in a group stacking together to form the columns. Preferably the ligaments of each plate of the group are displaced relative to those of adjacent plate(s) in the group whereby fluid flowing across the group is not only forced to follow a tortuous flow path around the columns but also over and under each ligament. The column precursors may be arranged in sectors, each sector separated from the next by a barrier of thickness (height) equal to the plate thickness. Alternate barriers will extend one from the outer peripheral edge of its plate towards but not reaching the central annular surround and the next from the annular surround towards but not reaching the outer peripheral edge. The outer peripheral edge will itself form a barrier to flow, i.e. it will be of height equal to the plate thickness. By this means the groups of plates are divided into sectors, adjacent sectors being one for inward flow, the next for outward flow and so on. Flow of fluid can pass from the inlet towards the central annular surround and in the valve closed condition, pass around the inner end of the first barrier to flow to the outer peripheral edge, around the end of the second barrier, back towards the central annular surround and so on until the outlet is reached. Where the outlet and inlet lie side by side, the barrier between their sectors of the plates will continue from the outer peripheral right up to the central annular surround to prevent flow continuing back into the inlet.

In another embodiment, the pairs of plates may have flow paths defined as described in our international patent application number PCT/GB98/01565, publication number WO 98/55812. In that application is described a heat exchanger comprising a bonded stack of plates, the stack comprising at least one group of main perforated plates, wherein at least two adjacent plates of the group of main perforated plates have their perforations aligned in rows with continuous ribs between adjacent rows and the adjacent plates are aligned whereby the rows of perforations in one plate overlap in the direction of the rows with the rows of perforations of an adjacent plate and the ribs of adjacent plates lie in correspondence with each other to provide discrete fluid channels extending across the plates, a channel corresponding to each row of perforations, the channels together forming one or more fluid passageways across the plates and the passageway(s) in the group of main perforated plates being separated from passageway(s) in any adjacent group of perforated plates by an intervening plate.

Thus the plates of each first group and, if desired, of each second group used in the present invention may be perforated plates having their perforations aligned in rows extending between the outer periphery and the central annular surround, the perforations, e.g. slots, of each row of one plate overlapping with those of an adjacent plate. Fluid may thereby flow across the group of plates in discrete fluid channels provided by the overlapping perforations and separated from adjacent channels by continuous ribs formed between the rows of perforations.

It is preferred that the plates be of the type having column precursors and ligaments as described in WO 99/66280. It will be appreciated that each sector of the plates of a group may need to be narrower nearer the centre than the periphery of the plates. In order, therefore, to prevent unwanted restrictions in the flow paths, which would cause undesirably high flow resistance, it is advisable to widen the spacing between any obstacles to flow as the centre of a plate is approached. This can more readily be achieved with the pin-fin type of arrangement as the column precursors can be formed of smaller diameter and/or their pitch or spacing can be increased as they near the central annular surround of a plate.

The plates may be of any conveniently shape in plan. Circular plan plates may be preferred but this is not essential and octagonal, hexagonal, square or any other desired, but preferably uniform, shape may be used.

The configuring of the plates to have any desired perforations, column precursors, ligaments, barriers and the like is preferably achieved by photochemically etching by known means although spark erosion, punching or any other suitable means may be used, if desired.

The plates of a stack are preferably of the same material and are preferably thin sheets of metal, e.g. of 0.5 mm thickness or less. The material may be stainless steel but other metals, e.g. aluminium, copper or titanium or alloys thereof, may be used.

As indicated above, the components of a stack may be bonded together by diffusion bonding or by brazing. Diffusion bonding, where possible may be preferred but, in the case of aluminium, which is difficult to diffusion bond, brazing may be necessary. It is then preferable to clad the aluminium surfaces, e.g. by hot-roll pressure bonding with a suitable brazing alloy, in order to achieve satisfactory bonding by the brazing technique, although other means to provide the braze medium may be used, e.g. foil or vapour deposition.

The heat exchangers of the invention are not limited to use for the passage of two fluids only through the stack of plates. They may readily be adapted for multi-stream flows by the provision of appropriate extra inlet and outlet means on the exterior of the plates and the connection of those extra means to groups of plates dedicated to receiving a third, fourth and so on further fluid.

Multi-streaming may advantageously be used in different ways.

In a first instance, exemplified by an aerospace example, the coolant, e.g. the fuel, may be used to cool two different, separate oil streams, namely a lubricating oil and a hydraulic oil.

In another instance, again exemplified by an aerospace example, two different coolant streams may be used. Thus in addition to using the fuel as a coolant, cold air may also be used as a separate coolant stream. The cold air maybe used to cool either or both of the oil and fuel streams, i.e. as the fuel is gradually used up, its temperature may rise and hence it may need cooling.

In another instance a third or further fluid streams may be introduced with a view to injecting one or more fluids into a process fluid. Thus, for example, the first fluid may be a process fluid to be reacted with a third fluid and the second fluid may be a coolant or may provide heat depending on whether the desired reaction is exothermic or endothermic. The injection of the third fluid into the second fluid may conveniently be achieved by replacing the solid plate between adjacent first and third groups of plates by a plate having injection holes through its thickness. The number, position and size of the holes can readily be determined by-the skilled man of the art to achieve the desired injection rate and the third fluid will, of course, need to be circulated into the stack at the higher pressure than the first fluid to achieve the desired flow through the injection holes.

Thus in this latter instance, the heat exchanger of the invention may be used as a chemical reactor.

Embodiments of the invention will now be described by way of example only with reference to the accompanying drawings in which:

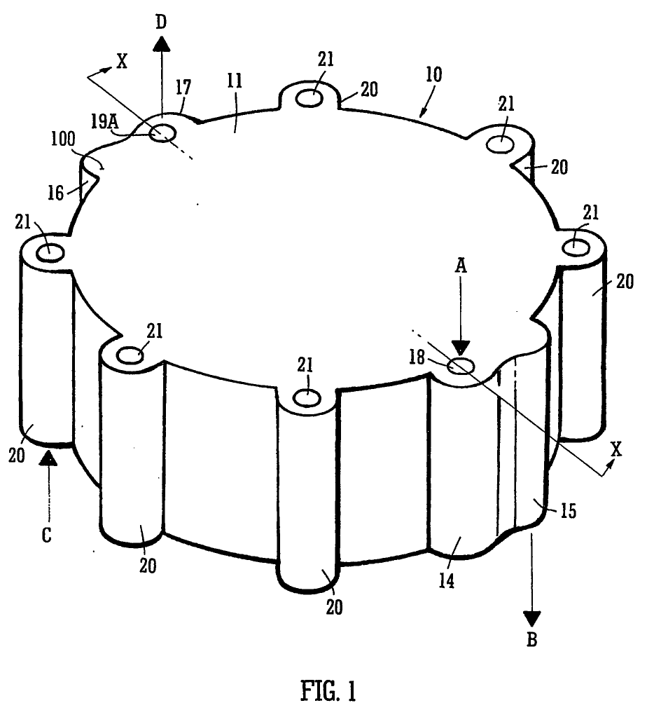

FIG. 1 is a perspective view of a first embodiment of heat exchanger according to the invention;

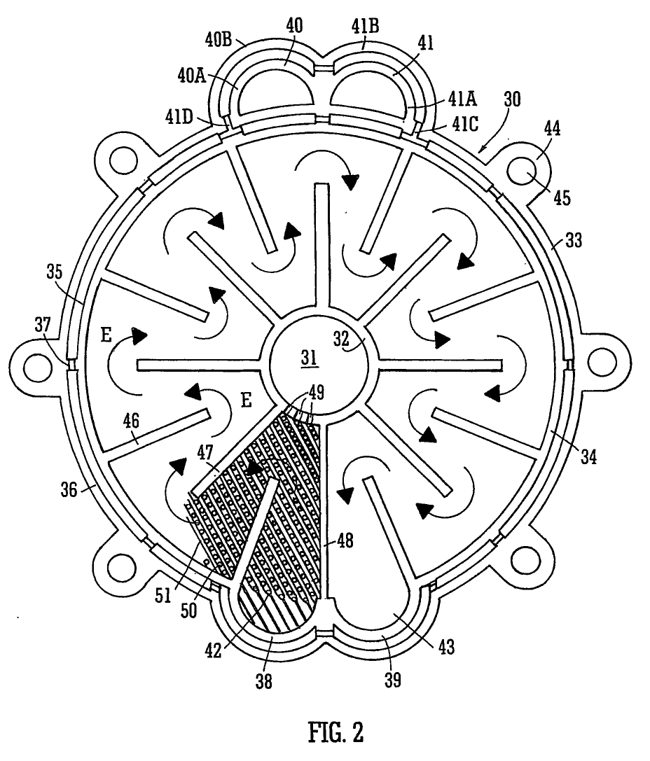

FIG. 2 is a plan view of a first plate for use in a first group of plates for use in the heat exchanger of FIG. 1;

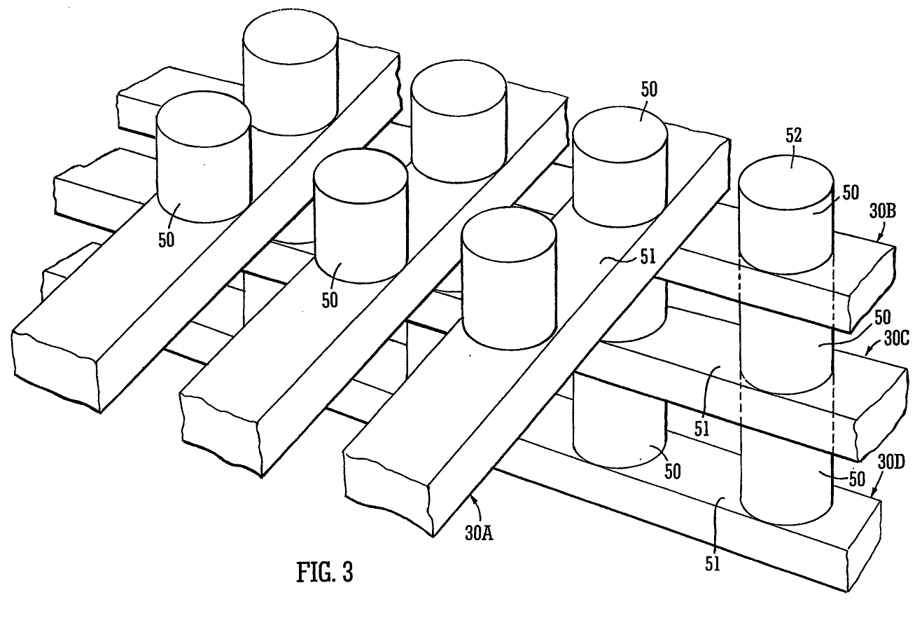

FIG. 3 is a perspective view of a portion of a first group of plates of FIG. 2 for use in the heat exchanger of FIG. 1;

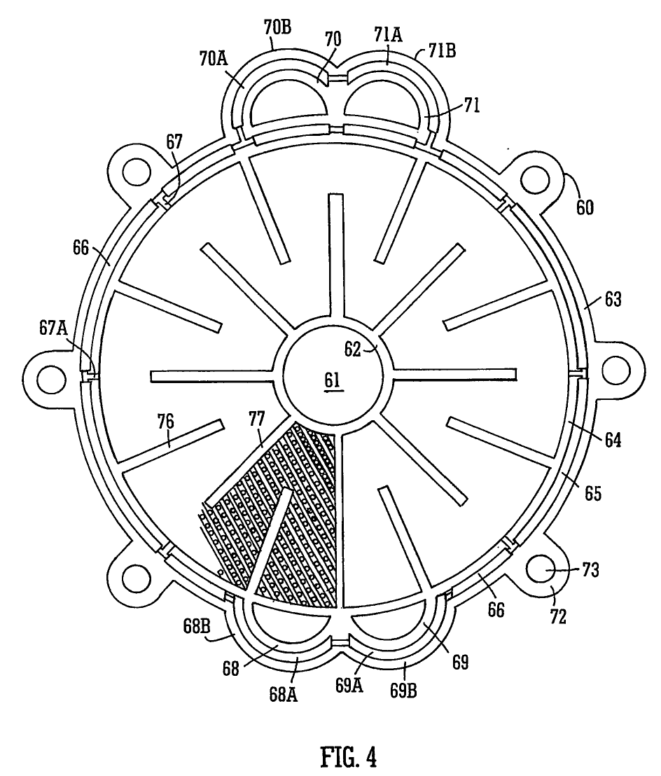

FIG. 4 is a plan view of a plate for use in an intervening group of plates for use in the heat exchanger of FIG. 1;

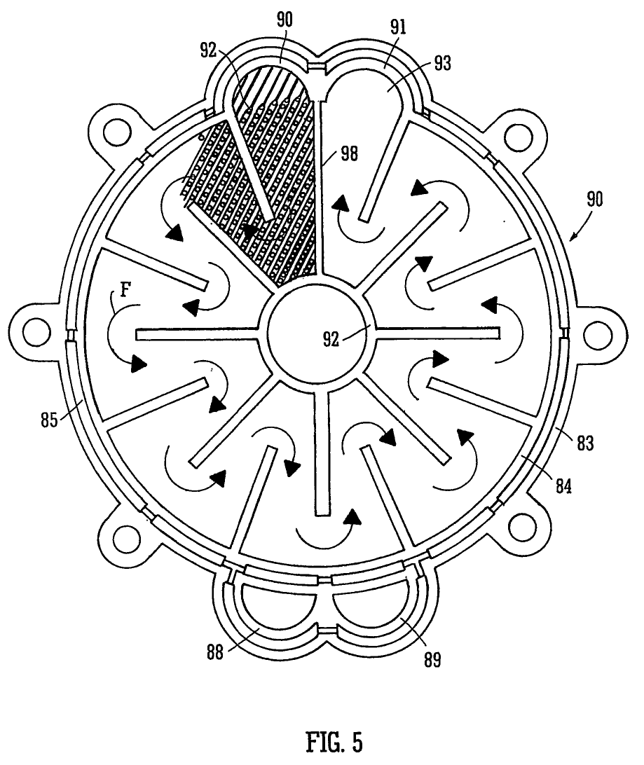

FIG. 5 is a plan view of a first plate for use in a second group of plates for use in the heat exchanger of FIG. 1;

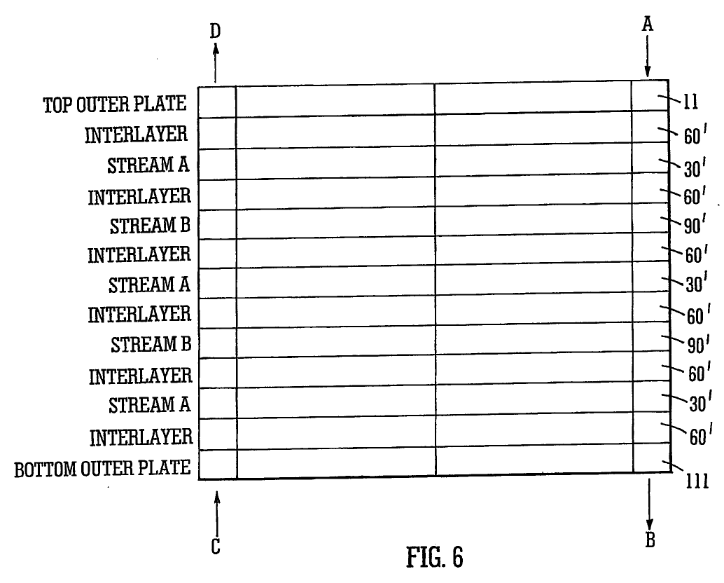

FIG. 6 is schematic view of a stack of plates according to the invention in the heat exchanger of FIG. 1;

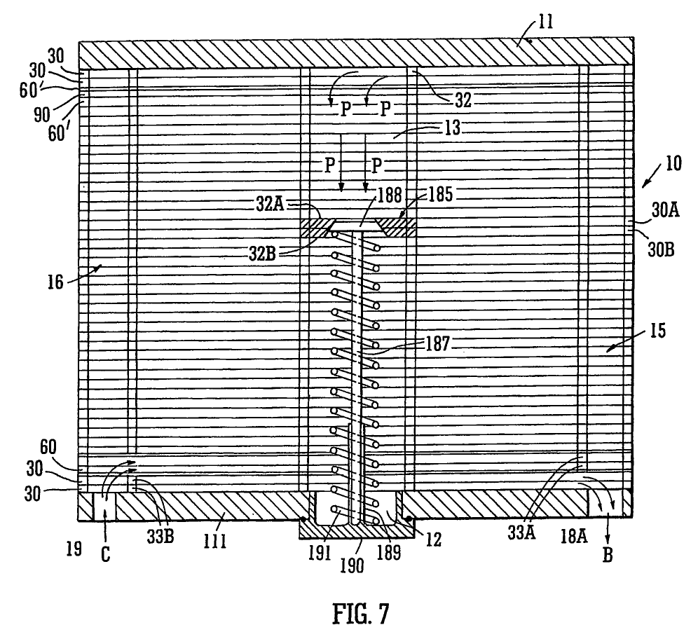

FIG. 7 is a section through the heat exchanger of FIG. 1 taken along a line corresponding to line X-X of FIG. 1 and showing a bypass valve in closed configuration;

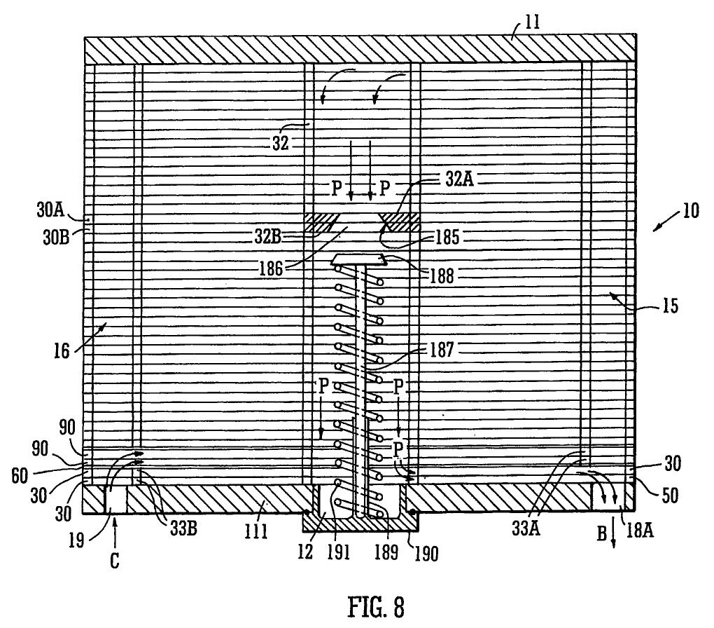

FIG. 8 is a similar section to FIG. 7 but showing the bypass valve in open configuration;

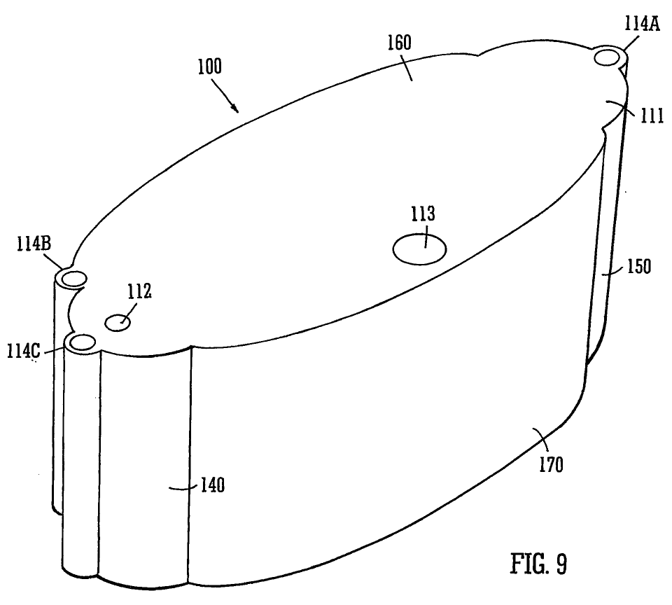

FIG. 9 is a perspective view of a second embodiment of heat exchanger according to the invention;

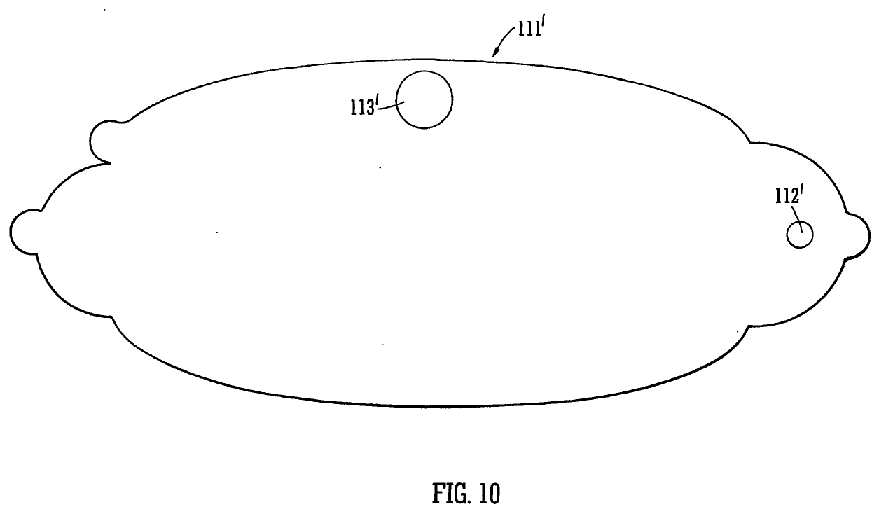

FIG. 10 is a plan view of a base plate for use in the heat exchanger of FIG. 9;

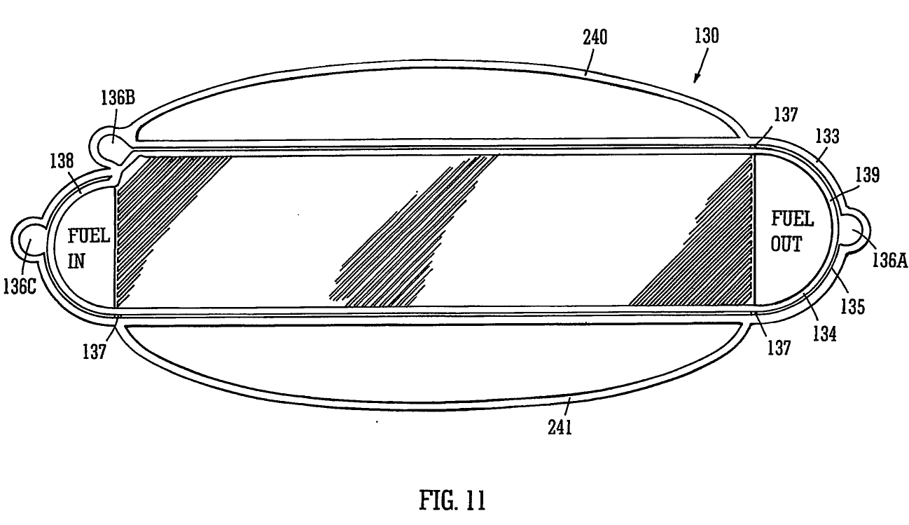

FIG. 11 is a plan view of a plate for a first fluid for use in the heat exchanger of FIG. 9;

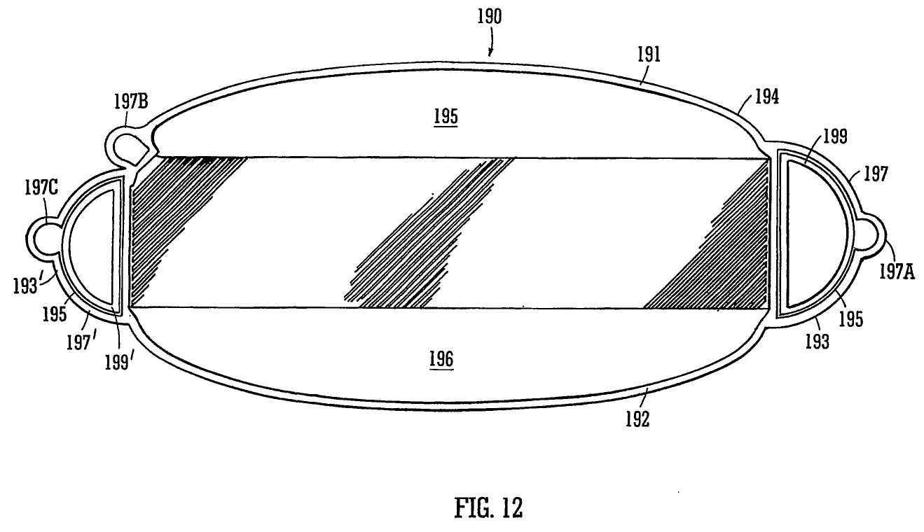

FIG. 12 is a plan view of a plate for a second fluid for use in the heat exchanger of FIG. 9;

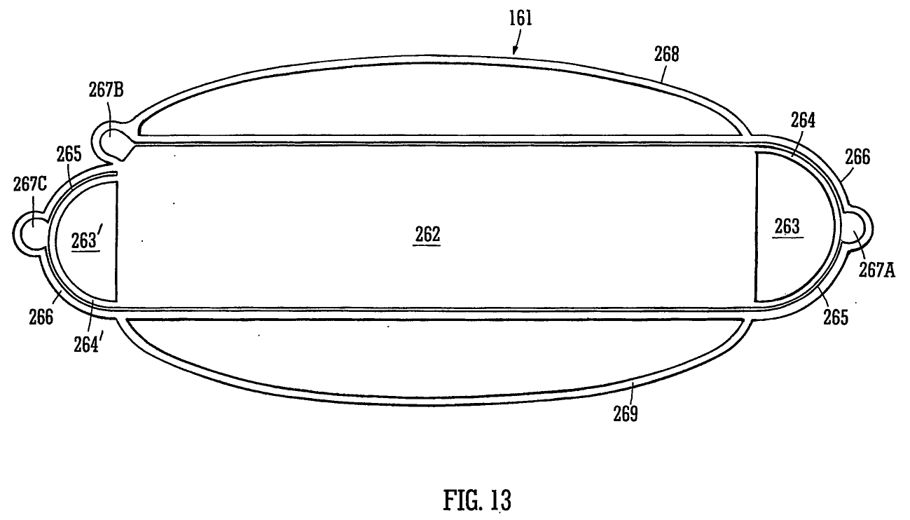

FIG. 13 is a plan view of a solid intervening plate for use in the heat exchanger of FIG. 9;

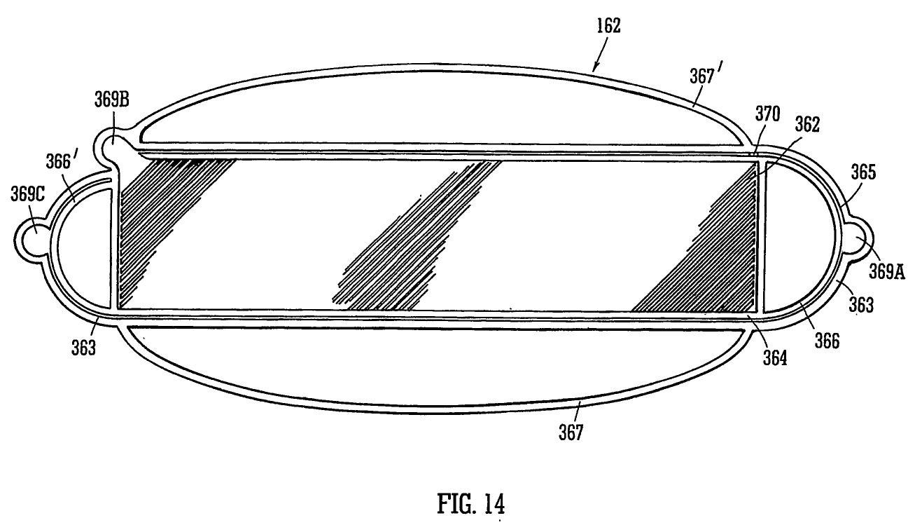

FIG. 14 is a plan view of an intervening layer plate for use in the heat exchanger of FIG. 9;

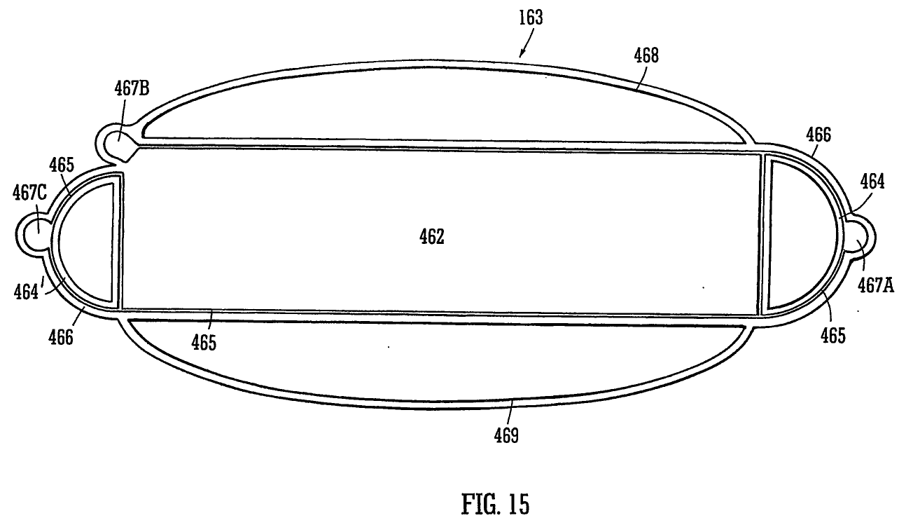

FIG. 15 is a plan view of a second solid intervening plate for use in the heat exchanger of FIG. 9; and

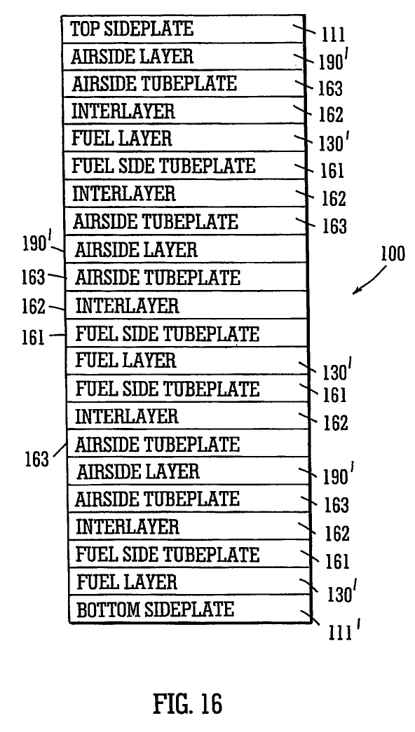

FIG. 16 is a schematic view of a stack of plates in the heat exchanger of FIG. 9.

In FIG. 1 there is shown a heat exchanger 10 formed from a bonded stack of plates. At the top of the stack is an end plate 11 which closes the top of the stack. The heat exchanger 10 has four integrally formed tanks 14, 15, 16 and 17 which are formed from the stacking of integrally formed loops on the outer peripheries of the plates of the stack, as will be explained below. The four tanks 14, 15, 16, 17 provide inlet and outlet means for a first and second fluid respectively. In this embodiment tank 14 is an inlet tank for a first fluid flowing in the direction of arrow A via hole 18 in top end plate 11, tank 15 is an outlet tank for first fluid flowing in the direction of arrow B via a corresponding hole in a bottom end plate of the stack. Although not visible in FIG. 1, the bottom end plate 11 A is of similar structure to top end plate 11 except that it has a central hole 12 which is closed by a plug. Tank 16 is an inlet tank for a second fluid flowing in the direction of arrow C via a hole in the bottom end plate 11 A and tank 17 is an outlet tank for second fluid flowing in the direction of arrow D via a hole 19A in top plate 11. The first and second fluids are circulated in opposite directions through the stack to improve heat transfer.

It will also be noted that the stack is formed with six longitudinally extending external columns 20, diametrically opposed in pairs across the stack. Each column has a through bore 21 to receive bolts whereby the heat exchanger may be bolted in its position for use. The columns 20 and their bores 21 are formed by corresponding extensions on each plate of the stack as is further described below.

A further aperture 100 is also present in the top plate 10, the function of which will become apparent below.

In FIG. 2 there is shown one of two plates of a first group of plates. This group of plates lies immediately beneath end plate 11 in the stack. Plate 30 of FIG. 2 has a central hole 31 defined by an annular surround 32. At its outer periphery, the plate 30 has an outer wall 33 which encompasses a continuous, relatively inner wall 34, a space 35 being defined therebetween. The walls 33, 34 either side of the space 35 are arranged to configure the space 35 with a plurality of circumferentially extending full thickness portions 36, adjacent portions 36 being interconnected by vents 37. The vents 37 are formed so that they extend only partially through the thickness of the plate 30, thereby providing the means through which the outer wall 33 is joined to the inner wall 34.

The plate 30 has an inlet extension loop 38 which in the stack forms part of tank 14 and an outlet loop 39 which forms part of tank 15. It also has extension loops 40 and 41 which form respectively pairs of tanks 16 and 17. It will be noted that loops 38 and 39 communicate with inlet sector 42 and outlet sector 43 respectively of the plate 30 whereby first fluid may flow in to sector 42 from tank 14 and out of sector 43 into tank 15. In contrast, loops 40 and 41 are separated from their respective adjacent sectors of the plate by continuations of the outer 33 and inner 34 walls so that there is no fluid communication between tanks 16 and 17 and this first group plate 30.

The inner wall 34 is extended to form the loops 38 and 39, the outer wall 33 also being extended in the region. Loops 40, 41 are comprised of joined inner loop portions 40A, 41A encompassed by outer joined loop portions 40B and 41 B, a space being defined therebetween which is in communication with the peripheral space 35 through vents 41 C and 41D.

Central hole 31 is coaxial with central holes in all the plates below plate 30, thereby forming a bore through the stack (other than through top plate 11) to receive a bypass valve as is described in greater detail below.

Plate 30 has six peripheral lugs 44 each with a central hole 45. The lugs and holes stack together with similarly positioned lugs and holes in the other plates of the stack to form columns 21 with bores 22.

Between its relatively inner wall 34 and its central annular surround 32, plate 30 is divided into sixteen sectors of which sector 42 and 43 are the respective first and last with regard to flow. (It will be appreciated that more or less sectors may be used and the positions of the inlet and outlet sectors may be varied.). Adjacent sectors are separated by radially extending partitions 46, 47 which alternate around the plate 30. Partitions 46 extend radially inwardly from wall 34 towards but do not reach annular surround 32. Partitions 47 extend radially outwardly from annular surround 32 but do not reach wall 34. The wall 34, partitions 46, 47 and central surround 32 have a height equal to the plate thickness. By this means, first fluid flow from tank 14 enters into inlet sector 42 and then flows around the plate 30 in the direction of arrows E to reach outlet sector 43. Barrier 48 between sectors 42 and 43 extends completely from the wall 34 to the annular surround 32 so that fluid cannot pass directly between the inlet 42 and outlet 43 sectors. The fluid, therefore, exits into tank 15, via outlet sector 43.

Each sector of the plate 30 has a pin-fin construction with column precursors 50 separated by ligaments 51 of reduced thickness. For convenience, the pin-fin construction is only illustrated in two sectors. It will be noted that the column precursors 50 do not extend into the tank areas inside the loops 38, 39, although, necessarily, the ligaments 51 do extend across those tank areas to attach to the wall 34, this being shown inside loop 38 only.

Central annular surround 32 is provided with holes 49 to provide fluid communication between the fluid flow sectors and the hole 31, i.e. they provide fluid communication into the central bore 13 of the stack. Only three such holes are shown by way of an example adjacent inlet sector 42 but, if necessary, more may be provided around the surround 32 in other sectors. These holes 49 enable the first fluid to act against the bypass valve and to operate the same, which will be described In greater detail below. As will be explained below, only the uppermost plate 30, or groups of plates 30A, B, C, D of a stack forming a heat exchanger will have holes 49.

FIG. 3 shows a portion of a stack of four plates 30A, 30B, 30C and 30D each being of the first plate 30 type to form a first group of plates (although greater or less than the number of plates 30 shown may be used). The ligaments 51 of at least two of the plates 30A and 30B are not aligned. Each plate 30A, 30B, 30C and 30D has a number of rows of column precursors 50, adjacent pairs of column precursors 50 being joined together by a ligament 51. Each column precursor 50 can be considered to extend for the full thickness of its plate and this is indicated in the right hand row of column precursors 52 where their continuation through the thickness of their plates 30A, 30B, 30C and 30D is shown by dotted lines. The column precursors of adjacent plates 30A, 30B, 30C and 30D, therefore, stack together to form columns 52 which cause turbulence in the fluid flow and provide heat transfer paths, as described below. The columns 52 also provide mechanical strength to resist internal pressure loads. The ligaments 51 being of lesser thickness than the plate thickness allow fluid flow above and beneath them to allow the flow path, with turbulence, to pass around the sectors of a plate.

First fluid flow around the first group of plates 30A, 30B, 30C and 30D in the general direction of arrows E has, therefore, induced turbulence by the need to flow around the obstructions caused by columns 52 and the need to flow over and under the staggered ligaments 51.

The first group of plates 30A, 30B, 30C, 30D is separated in the stack from an adjacent second group of plates by an intervening layer of plates which comprises one or more interlayer plate(s) as shown in FIG. 4, sandwiched between two solid portion plates.

Referring to FIG. 4, the interlayer plate 60 has central hole 61 defined by an annular surround 62. At the outer periphery of plate 60 it has an outer wall 63 encompassing a relatively inboard wall 64, there being defined a space 65 therebetween. The walls 63, 64 either side of the space 65 are arranged to configure the space 65 with a plurality of circumferentially extending full thickness portions 66, adjacent portions 66 being interconnected by vents 67. The vents 67 are formed so that they extend only partially through the thickness of the plate 60, thereby providing the means through which the outer wall 63 is joined to the inner wall 64.

The space 65 is in communication with the inboard region defined by the inner wall 64 by vents 67A which are in fluid communication with vents 67.

The inboard region of the plate 60 is divided into sixteen sections (as per plate 30, although fewer or more sections could be provided) by radially extending partitions 76, 77. Partitions 76 extend from the inner wall towards, but not to, the annular surround 62 and partitions 77 extend from the annular surround 62 towards but not to inner wall 64. Thus, a flow path is present around the plate 60. The sectors of the plate 60 defined by the partitions 76, 77 have the ‘pin-fin’ arrangement discussed above.

The plate 60 is further provided with loops 68, 69, 70, 71 which extend from the inner wall 64. None of the loops 68, 69, 70, 71 are in fluid communication with the inboard region defined by the inner wall 64. An outer wall 68B, 69B, 70B, 71B encompasses respective loops 68, 69, 70, 71 to define a respective space 68A, 69A, 70A, 71A therebetween. The space 68A, 69A, 70A, 71A being in fluid communication with space 65.

Each of the annular surround 62, walls 63, 64, loops 68, 69, 70, 71, outer walls 68B, 69B, 70B, 71B and partitions 76, 77 and column precursors are the height of the plate 60. The vents 67, 67A and ligaments typically extend for half the height of the plate 60.

Plate 60 also has six lugs 72 with holes 73 to line up in the stack to form part of columns 20 with bores 21.

When more than one plate 60 is required, the ligaments of the pin-fin arrangement will extend in a direction normal to that shown in FIG. 4. Thus, the column precursors of the adjacent plates 60 will align but the ligaments will not, providing a tortuous flow path.

The solid portion plates between which the interlayer plate or plates 60 are sandwiched are identical with the exception that the inboard region is solid and vents 67A are absent. Thus, the solid plate has a central hole defined by a solid surround which extends to an annular space, to correspond with that of plate 60, the circumferential portions being interconnected by vents. An outer wall defining loops and lugs as per FIG. 6 is present.

As will be clear, a sandwich of solid portion plate, one or more interlayer plate(s), solid plate will provide a chamber of the aligned spaces 65 along the sandwich. Fluid communication with the inboard region of the plate 60 being available through the spaces 65 and vents 67, 67A.

The plates of the second groups of plates may be of any appropriate configuration to provide flow channels for the second fluid. As shown in FIG. 5, plates 90 for the second fluid may be similar to plates 30A, 30B, 30C, 30D but with the following differences. Firstly, the second group plates do not have holes 49 in central annular surrounds 92 as second fluid must not pass into the central bore 13 of the stack. Secondly loops 90 and 91 open into their respective sectors (by removal of the portion inner 34 and outer wall 33 that is closing them off from those sectors in plates 30). Thirdly, loops 88 and 89, which in plate 30 open into their respective sectors 42 and 43 are closed off from those sectors by appropriate extensions of the outer wall 83 and continuous inner wall 84. In other words, the configurations of loops 38 and 39 on the one hand and loops 40 and 41 on the other hand must be exchanged to provide loops 88, 89, 90, 91. Finally, the barrier 98 of plate 90 is provided between loops 90 and 91 to allow fluid to flow from inlet region 92 to outlet region 93 in the direction of arrows F.

FIG. 6 shows a typical stack of plates with a top plate 11, followed by an intervening group of plates 60′ comprising an interlayer plate 60, a first group of plates 30′ having one or more plates 30, an intervening group of plates 60′, second group of plates 90 ′ having one or more plates 90, an intervening group of plates 60′ and so on and terminating in a bottom end plate 111. The arrows show the direction of flow as indicated in FIG. 1.

Because of the solid portion plate of the intervening group of plates 60′ there can be no fluid communication between a first fluid flowing through the first groups of plates 30′ and the second fluid flowing through the second group of plates 90 ′.

It will be appreciated that once the groups of plates 11, 30′, 60′, 90′, 111 are stacked together and joined together by, say, diffusion bonding or brazing a fluid pathway through the stack for each of the first and second fluids is provided. Loops 38, 68, 88; 39, 69, 89; 40, 70, 90; 41, 61, 91 are aligned to form the tanks 14, 15, 16 17 and the annular surrounds are aligned to form the central bore 13. The fluids will transfer heat between one another across the intervening group of plates 60′. Clearly the greater the density of contacts in the intervening groups of plates 60′ (i.e. those which contact the solid plates) the better the heat exchange capacity.

Once the stack is bonded, the spaces 35, 65, 85 are in fluid communication with one another to form a chamber, which is in communication with the inboard regions of plates 60. Plate 111 overlies the chamber to seal it at that end. Plate 11 has an aperture 100 which is in communication with the chamber. If either fluid should leak from between the bonded plates 30, 90 due to incomplete or inaccurate bonding or through failure due to wear and the like, it will leak into the chamber causing a sudden rise in the pressure in the chamber. A valve or pressure transducer which Is arranged to monitor the pressure within the chamber or across the aperture 100 (FIG. 1) will show an increase in pressure if a leak should occur. This pressure increase can be used to alert an operator or other system monitoring the heat exchanger to warn of a leakage. Further, should the solid portion plate of the intervening group of plates fail, the fluid will pass into the inboard region of the interlayer plate 60, from where it will flow via the vents 67A into the chamber, causing a pressure rise in the chamber.

In high-pressure systems, such as those used on aircraft to cool oil and pre-heat fuel, the pressures are such that even small leaks will cause relatively large pressure rises in the chamber. Thus the, say, pilot, will be warned of a fuel or oil leak and can take appropriate action.

In FIGS. 7 and 8 are shown sections through the heat exchanger 10 of FIG. 1 with a bypass relief valve positioned in the central bore 13 in the valve closed position and valve opened position. Operation of the heat exchanger 1, in this regard, is in accordance with our co-pending international (PCT) patent application no. PCT/GB

02/02636 (the entire disclosure of which is herein incorporated by reference). The chambers defined by the spaces are not shown for reasons of clarity.

The stack of plates has a top plate 11 immediately underneath which lie one or more plates 30 of FIG. 2 and 3. Underneath plates 30 is an intervening group of plates 60′ to separate first fluid flowing around plates 30 from second fluid flowing around the next pair of plates 90, which form a second group of plates for a second fluid. Beneath plate 90 is another intervening group of plates 60′ and this pattern is repeated down the stack as per FIG. 6.

The plates of the first groups in the stack, other than in the uppermost and lowermost first groups also need modification from plates 30. They may be identical to plates 30 except in the provision of holes 49 in central annular surround 32. It is a desideratum, in this embodiment of the invention, that the first fluid only flows into and out of the central bore 13 via the uppermost and lowermost first groups of plates 30′ respectively. Plates of other, intermediate first groups, therefore, have central annular surrounds that are unperforated.

A bypass valve is fitted into central bore 13. It has a valve seat 185 positioned in the upper half of the bore and defining a tapering central hole 186. A valve stem 187 with a head 188 shaped to close the hole 186 extends in the bore 13. The stem 187 can slide in and out of a hollow lower stem base 189 which is integral with plug 190 which closes the lower end of bore 13. The stem is normally held in its extended position closing hole 186, and hence closing bore 13, by means of a spring 191.

Valve seat 185 may be formed by any convenient means. It could be a separate fitting, bonded into place in bore 13 preferably at the time of bonding of the stack. However, it is preferred to be integrally formed by appropriate sizing of the central holes in the group or groups of plates at the position in the stack where the valve seal is required. Thus, as is shown in FIGS. 7 and 8, plates 30A and 30B have central annular surrounds 32A, 32B respectively that define smaller holes than holes 31 of the other plates. Surround 32A defines a smaller central hole than surround 32B and the inner edges of the surrounds are chamfered to produce the tapered valve seat 185. However, in practice it may be found that in order to achieve a satisfactory valve seat, it is necessary to use more than the thicknesses of two plates to provide the seat. Moreover, rather than forming the tapered hole 186 by tapering of the edges of the central holes of the plates during etching or otherwise forming of the holes, it is preferred to form the plates in the seat region with a smaller central hole and then to machine the required hole size and edge shape through the hole 12 and bore 13 in the bonded stack.

The valve seat may be located at any convenient position along the bore. The skilled man will readily choose a position for his requirements taking into consideration factors such as the length of spring 191 and the head of first fluid that may gather above the valve seat in the valve closed position.

In the valve closed position, shown in FIG. 7, first fluid enters the stack at inlet 13, see arrow A (FIG. 1), and fills tank 14. From sectors 42 of first plates 30 at the top of the stack it can flow into bore 13 via holes 49 in the central annular surrounds of those plates, again as indicted by arrows P. However, as the valve is closed, first fluid cannot flow further down bore 13. The first fluid can only travel through the stack, therefore, in the valve closed position around each successive pair of first plates 30 along the stack, the fluid travelling from their plate inlet sectors 42 to their outlet sectors 43 to leave via tank 15 and outlet 18A, see arrow B, in the lowermost pair of plates. In tanks 14 and 15 first fluid bypasses each pair of second plates 90 because the loop extensions in the second plates will have peripheral rim extensions 33A in the sectors where they form part of the first fluid tanks 14 and 15.

Second fluid enters the stack at inlet 19, see arrow C, and while filling inlet tank 16 it similarly travels around each pair of plates 90 from their inlet sectors 92 to their outlet sectors 93, to reach outlet tank 17 and then outlet 19A, see arrow D.

The bypass valve open position is shown in FIG. 8. Second fluid flow is the same as in the closed position and so is not repeated here other than to show it entering at inlet 19—arrow C. First fluid again enters at inlet 18 (as shown in FIG. 1) to fill tank 14 but will now preferentially flow into bore 13, see arrows F, and through the bore to its lower end. As that end is sealed by plug 190, the first fluid travels via holes 49 In the lowermost plates 30, 50 and passes around those plates to reach outlet 18A, see arrow B.

The bypass valve is held in the closed position during normal operating conditions by compression spring 191. However, at start up of the engine with which the heat exchanger is used, the oil being cold is pumped at higher than normal pressure. This pressure forces the valve head 188 away from its seat 185 by compression of the spring 191, thereby allowing the oil to pass centrally down the bore 13 to its lower end. As the oil warms up, the pressure reduces and the spring will close the valve, thereby preventing the warmer oil from avoiding its alternative cooling passage through the heat exchanger.

Thus, the heat exchanger of this invention provides leak detection means during operation of the exchanger 10. The pressure valve or transducer to detect the leak can be replaced by any suitable means, such as spectrographic detection equipment or indicator chemicals. The provision of the integrally formed outer wall allows for a chamber to be formed to contain and detect a leak. Such heat exchangers, when used in aircraft for the cooling of oil, will allow a pilot an opportunity to shut down the engine before a dangerous level of fuel or oil has leaked from their respective circulation systems.

The plates need not be of the shape shown, they may be of any matched configuration as considered in our above referenced co-pending patent applications.

It will be appreciated that by using photochemical etching, spark erosion, punching, high-pressure water cutting and like techniques each plate can be manufactured as a single unit. Therefore, there is no need for further additions to the heat exchanger to form leak detection chambers. This makes manufacture both simpler and less consuming in terms of time and capital.

An inner annulus may be provided on each plate to form an annular compartment once the plates are stacked together, to accommodate any leaks which would otherwise enter the bore.

It will further be appreciated that the heat exchanger plates need not have a bore to accommodate a bypass valve. Each plate may simply comprise a partition preventing fluid in a group of plates, from flowing directly from the inlet to the outlet.

An example of such a heat exchanger 100 is shown in FIG. 9 which may be used, for example, to cool or heat fuel with cooled or heated air (usually fuel will be pre-heated before combustion to increase burn efficiency of the engine or may be heated to remove ice crystals present therein). The heat exchanger 100 is formed from a bonded stack of plates. At the top of the stack is a top end plate 111 which closes the stack and is provided with an inlet 112 for a first fluid and an outlet 113 for a second fluid. Also located in the end plate 111 are three drain ports 114A, B and C, the purpose of which will be described below. The plates stack together to form an inlet tank 140 and outlet tank 150 for the first fluid and inlet tank 160 and outlet tank 170 for the second fluid.

At the bottom of the stack is a bottom end plate 111′ which is shown in FIG. 10, having an outlet 112′ for a first fluid and an inlet 113′ for a second fluid (it will be noted that the there are no drain ports corresponding to those in the top end plate 111).

FIG. 11 shows a typical plate 130 for the circulation of a first fluid. The plate 130 has an outer wall 133 which encompasses a continuous relatively inboard wall 134, a space 135 being defined therebetween, the walls 133, 134 being interconnected by vents 137, which vents 137 are typically half the thickness of the plate 130. The outer wall 133 has three smaller extension portions 136A, B, C which communicate with the space 135 and, in the completed stack 100, communicate with the drain ports 114A, B, C. The space 135 and small extension portions 136A, B, C are not in fluid communication with any other part of the plate 130.

The wall 134 has an inlet extension loop 138 and an outlet extension loop 139 for the inlet and outlet of the first fluid, the loops 138, 139 stacking together to form inlet and outlet tanks 140, 150 for the first fluid. The area between the inlet and outlet loops 138, 139 is provided with ligaments and column precursors, as described above with reference to FIG. 2 and 3, for example (although not shown as doing so, the ligaments will extend into the loops 138, 139). As before, a plurality of such plates 130 may be stacked together to form a first group of plates 130′ for the passage of a first fluid.

The outer wall 133 is provided with a pair of extension loops 240, 241 which are not in fluid communication with the first fluid flow path, through which the second fluid flows and which, in the completed stack 100, form part of the second fluid inlet and outlet tanks 160, 170.

FIG. 12 shows a plate 190 for the passage of a second fluid having a continuous wall 194 which is extended to form a pair of loops 191, 192 to provide inlet and outlet ports 195, 196 for the second fluid which, in the completed stack 100 form part of second fluid inlet and outlet tanks 160, 170. As above, the region between the inlet and outlet ports 195, 196 is provided with ligaments and column precursors, the ligaments extending into the ports 195, 196.

The wall 194 has outer walls 193, 193′ extending therefrom to form extension loops 197, 197′. The extension loops 197, 197′ are provided with extension portions 197A and 197C respectively. A further extension portion 197B extends from the continuous wall 194. Located within each extension portion 197, 197′ is a wall 199, 199′ connected to respective extension loops 197, 197′ by half thickness vents, a space 195 being defined therebetween which communicates with extension portions 197A and 197C. The space 198 is not in fluid communication with either fluid flow path. The walls 199, 199′ define a space through which the first fluid flows and which, in the completed stack 100, form part for the inlet 140 and outlet 150 tanks for the first fluid.

Again, a plurality of plates 190 may be stacked together to form a second group of plates 190 ′.

In the heat exchanger 100, the first and second groups of plates 130′, 190 ′ are separated by an interlayer or interlayer group of plates. FIGS. 13, 14 and 15 show the three plates 161, 162 and 163 which are stacked together to provide an interlayer group 160′.

FIG. 13 shows an interlayer plate 161 which is used to sandwich the first plate 130 or group of plates 130′. The plate 161 has a solid portion 262 to which is joined two extension portions 264, 264′ which define first fluid flow paths 263, 263′ which, in the completed heat exchanger 100 are stacked to form part of the first fluid inlet and outlet tanks 140, 150. The plate 161 has an outer wall 266 which is distant from the solid portion 262 and extension portions 264, 264′ to provide a space therebetween 265 which communicates with extension portions 267A, B, C, the extension portions 267A, B, C, in the completed stack, forming part of drain ports 114A, B, C. Attached to the outer wall 266 are extension loops 268, 269 which, in the completed heat exchanger 100, stack to form part of the second fluid inlet and outlet tanks 160, 170.

FIG. 14 shows an interlayer plate 162 having a wall 364 defining a region 362 provided with ligaments and column precursors, which region 362 being in fluid communication with a space 365 located between wall 364 and a relatively outer wall 363. The space 365 communicates with three extension portions 369A, B and C which, when stacked together in the completed heat exchanger 100, form part of the drain ports 114A, B and C.

The wall 364 has extension portions 366, 366′ extending therefrom which, when stacked together in the completed heat exchanger 100, form part of the inlet 140 and outlet 150 tanks for the first fluid. The outer wall 363 is provided with extension loops 367, 367′ which, when stacked together in the completed heat exchanger 100, form part of the inlet 160 and outlet 170 tanks for the second fluid.

FIG. 15 shows an interlayer plate 163 which is used to sandwich the plate 190 or group of plates 190 ′ for the second fluid. The plate 163 has a solid portion 462 which is bounded by an outer wall 466. Located within the outer wall 466 are a pair of closed walls 464, 464′ which, in the completed heat exchanger 100 are stacked to form part of the first fluid inlet and outlet tanks 140, 150. The outer wall 466 which is distant from the solid portion 262 and closed walls 464, 464′ to provide a space therebetween 465 which communicates with extension portions 467A, B, C, the extension portions 467A, B, C, in the completed stack, forming part of drain ports 114A, B, C. Attached to the outer wall 466 are extension loops 468, 469 which, in the completed heat exchanger 100, stack to form part of the second fluid inlet and outlet tanks 160, 170.

FIG. 16 shows an array of plates 130′, 190′, 161, 162, 163 between plates 111 and 111′ which form a heat exchanger 100.

Any leakage of the first or second fluids due to wear or incomplete fabrication will occur into the spaces 135, 198 and the corresponding spaces in the interlayer plates 161, 162, 163. A pressure or other sensor will be connected to one or all of the drain ports 114A, B, C to monitor or sensor such leaks.

A particular use for the heat exchanger 100 of FIG. 9 is the heating of fuel by heated air, the fuel being the first fluid and the air being the second fluid.

The heat exchanger 100 of FIG. 9 is only provided with a space into which a leak can occur around the first fluid flow path. This is particularly useful if, as in the case with a fuel/air heating system described above, the second fluid (air) is not dangerous or harmful or cannot react with other ambient species to become a dangerous (e.g. explosive or inflammable) substance.

As stated previously, more than one fluid may be heated and or cooled, as will be appreciate by the skilled addressee. Further, two fluid flows may be mixed in a layer to react two fluid streams together, thereby turning the heat exchanger into a chemical reactor. A suitable chemical reactor which may be adapted in accordance with the current invention is disclosed in our International (PCT) Patent Application No. PCT/GB01/05131 (published as WO 02/42704), the entire disclosure of which is herein incorporated by reference.

Other variations which fall within the ambit of the attached Claims are intended to form part of the inventive concept, as will be appreciated by the skilled addressee.

1-29. (canceled)

30. Heat exchange and/or chemical reactor apparatus comprising a series of plates which are stacked and bonded together in a fluid-tight manner, the series of plates comprising alternate first and second plates or groups of plates along the stack providing flow paths for respective first and second fluids, each plate forming said first and second plates or groups of plates having an inlet and an outlet between which respective first or second fluid is flowable and a continuous wall to contain the flow of fluid, and wherein each plate comprises an outer wall at least partially encompassing the continuous wall to define a space therebetween, the spaces of each plate of the stack being in fluid communication to form a compartment running along the stack.

31. Apparatus according to claim 30, wherein each continuous wall comprises integral, outwardly extending loops the loops being stacked together to provide inlet and outlet reservoirs for first and second fluids the respective reservoirs communicating with the flow paths of the groups of plates via the inlet and the outlet for the respective fluids into and out of their respective groups of plates.

32. Apparatus according to claim 31, wherein the outwardly extending loops of the first plate or stack of plates provide the inlet and outlet for the first fluid.

33. Apparatus according to claim 31, wherein the outwardly extending loops of the second plate or stack of plates provide the inlet and out for the second fluid.

34. Apparatus according to claim 30, wherein the alternate first and second plate or group of plates are separated by a single intervening plate or intervening group of plates.

35. Apparatus according to claim 34, wherein the first and second plates or groups of plates are separated by an intervening group of plates which comprise a sandwich of single intervening plate—one or more interlayer plates—single intervening plate.

36. Apparatus according to claim 35, wherein the or each interlayer plate comprises an interlayer first wall and a continuous outer wall encompassing the first wall to define an interlayer space therebetween, the region defined by the first wall being in fluid communication with said interlayer space.

37. Apparatus according to claim 36, wherein the interlayer first wall comprises one or more vents extending through, say, half the thickness of the interlayer plate to provide fluid communication between the interlayer space and the region defined by the first wall.

38. Apparatus according to claim 36, wherein the interlayer space comprises part of the compartment in the stack of plates, which compartment, consequently, being in fluid communication with the region defined by the first wall of the interlayer plate.

39. Apparatus according to claim 34, wherein at least one of the single intervening plate has a solid portion to prevent fluid communication between said first and second groups of plates or between said first or second group of plates and the or each interlayer plate.

40. Apparatus according to claim 39, wherein the single intervening plate comprises an outer wall encompassing and joined to its solid periphery, a space being defined between the outer wall and the solid periphery which, in the stack of plates, communicates with the spaces of the plates of the first and second groups of plates, and interlayer plate if present, to comprise a portion of said compartment.

41. Apparatus according to claim 30, wherein said compartment is sealed at either end of the apparatus.

42. Apparatus according to claim 30, wherein said compartment is in operative communication with detection means, said detection means being operable to detect the presence of either or both of said first and second fluids in said compartment.

43. Apparatus according to claim 42, wherein said detection means may be selected from one or more of pressure sensors, such as valves or pressure transducers or devices which can directly detect or indicate the presence of leaking fluids such as spectrometers, spectrographs.

44. Apparatus according to claim 30, wherein, in normal operation, the compartment is maintained at a pressure less than that experienced by the first and/or second fluids in the apparatus.

45. Apparatus according to claim 30, wherein each plate of the stack comprises a centrally disposed hole defined by a surround, the aligned holes forming a bore through the stack.

46. Apparatus according to claim 45, wherein the surround or surrounds of a first plate or group of plates adjacent one end of the stack have one or more apertures leading into the central bore.

47. Apparatus according to claim 46, wherein the bore contains a movable valve member which, in a first position, prevents flow through the bore and, in a second position, provides a fluid bypass route through the bore.

48. Apparatus according to claim 47, wherein the movable valve member has a stem and valve seat, the latter co-operating with a corresponding seat defined in the central bore.

49. Apparatus according to claim 47, wherein operation of the bypass valve is temperature and/or pressure controlled.

50. Apparatus according to claim 30, wherein the first plate or groups of plates and/or the second plate or group of plates, in the flow path between the inlet and outlet thereof, contains column precursors and ligaments.

51. Apparatus according claim 50, comprising first and/or second groups of plates wherein the column precursors of adjacent plates in a group stack together to form the column and ligaments of each plate of the group are displaced relative to those of adjacent plate(s) in the group whereby, in use, fluid flowing across the group is not only forced to follow a tortuous flow path around the columns but also over and under each ligament.

52. Apparatus according to claim 51, wherein the column precursors are arranged in sectors, each sector separated from the next by a barrier of thickness (height) equal to the plate thickness.

53. Apparatus according to claim 52, wherein alternate barriers extend one from the outer peripheral edge of its plate towards but not reaching the centre, and the next from or towards the centre towards but not reaching the outer peripheral edge.

54. Apparatus according to claim 30, comprising first and second groups of plates, the first and/or second groups of plates comprising a group of main perforated plates, wherein at least two adjacent plates of the group of main perforated plates have their perforations aligned in rows with continuous ribs between adjacent rows and the adjacent plates are aligned whereby the rows of perforations in one plate overlap in the direction of the rows with the rows of perforations of an adjacent plate and the ribs of adjacent plates lie in correspondence with each other to provide discrete fluid channels extending across the plates, a channel corresponding to each row of perforations, the channels together forming one or more fluid passageways across the plates and the passageway(s).

55. An aircraft comprising apparatus according to claim 30 used to cool lubricating oil with fuel, the first fluid being oil, the second fluid being fuel.

56. An aircraft comprising apparatus according to claim 30 used to heat fuel with heated air, the first fluid being fuel the second fluid being air.

57. Apparatus according to claim 30, comprising one or more flow paths for subsidiary fluids, the apparatus comprising means arranged to inject said subsidiary fluids into the flow of the one or both of said first and second fluids.

58. Apparatus according to claim 57, comprising a third plate or group of plates for a subsidiary fluid, an intervening plate being present between said third plate or group of plates and one or both of said first and second plate or groups of plates, the intervening plate having holes through its thickness to allow said third fluid to be injected into the flow of said first and/or second fluid.
